(19) United States
(12) Patent Application Publication
(10) Pub. No.: US 2009/0069462 A1
(43) Pub. Date: Mar. 12, 2009

(54) Additive Used for Treating Clay/Salt in situ Materials for Aggregates for Cement Mortar and Cement Concrete

(76) Inventors: Nguyen Hong Binh, Ho Chi Minh City (VN); Tran Ngoc Lam, Ho Chi Minh City (VN); Nguyen Hong Anh, Ho Chi Minh City (VN); Nguyen Hong Minh, Ho Chi Minh City (VN)

Correspondence Address: DONN K. HARMS;PATENT & TRADEMARK LAW CENTER, SUITE 100, 12702 VIA CORTINA, DEL MAR, CA, 92014, US

(21) Appl. No.: 12/271,883

(22) Filed: Nov. 15, 2008

Related U.S. Application Data
(63) Continuation-in-part of application No. 11/635,259, filed on Dec. 6, 2006, now abandoned.

(30) Foreign Application Priority Data
Dec. 19, 2005 (VN) 1-2005-01867

(51) Int. Cl. C04B 28/04; C08K 5/00

(52) U.S. Cl. 524/8; 524/158

(57) ABSTRACT

A method and additive for mixing cement and concrete with aggregates formed of soil and ground material proximate to the job site which are conventionally unsuitable for the purpose. Employing the method and additive, unsuitable in situ materials, such as soil, soil containing clay, clay containing stone, clay containing sand, gravelly soil, saline-sand, and soil saturated with saline contaminated water may be employed as aggregates for cement mortar and cement concrete without concern for water-reabsorption and into such materials once the concrete has hardened to a solid solution of cement and the in situ materials.

This application is a Continuation-in-Part of U.S. application Ser. No. 11/635,259 filed Dec. 6, 2006 claiming the benefit of Viet Nam Patent Application 1-2205-01867 filed Dec. 19, 2005 both of which are herein incorporated by reference in their entirety.

### FIELD OF THE INVENTION

This invention relates to an additive (hereinafter referred to as CSSB) used for treating clay and salt and unsuitable in situ building materials, such as soil, soil containing clay, clay containing stone, clay containing sand, gravelly soil, saline-sand, and saline contaminated water in order to turn them into aggregates. The invention also relates to method for making such CSSB additives.

### BACKGROUND OF THE INVENTION

Unsuitable in situ building materials, soil containing clay, clay containing stone, clay containing sand, gravelly soil, saline-sand, soil or clay saturated with saline contaminated water cannot be used for making concrete by traditional methods.

Cement-mortar and cement-concrete are a mixture of aggregates with a high-grade Portland cement being a common binder. The aggregates most commonly used in cement mortar and cement concrete are fresh sand (yellow sand or river-sand), fresh gravel or stone. High-grade Portland cement is a common binder. The aggregates and binder are mixed together with fresh water (soft water). Upon hydration the binder solidifies and binds the aggregates together into a solid mass.

A problem with the use of the unsuitable in situ building materials for aggregates in concrete and mortar compositions to build infrastructure projects is that most common binders, such as Portland cement, do not adhere well to them. The result is that concrete and mortar using in situ materials for aggregates is significantly weaker than ordinary concrete and mortar, for several reasons.

Firstly, when soil containing clay, clay containing stone, clay containing sand, gravelly soil, saline-sand, and saline contaminated water were utilized in the concrete mix used to build structures in the South of Vietnam, for example, the high clay content of such alluvium caused extensive expansion within the concrete and mortar as well as cracking, and spalling of the concrete when dry.

Secondly, NaCl in water will be separated into Na⁺ and Cl⁻, and FeO, MgO, AlO in Portland cement will be separated in the hydrating process of cement into cations Fe⁺⁺, Al⁺⁺⁺ and Mg⁺⁺. When mixing such aggregates with cement, cations Fe⁺⁺, Al⁺⁺⁺ and Mg⁺⁺ are attracted to ion Cl⁻, creating dissolving compounds, such as iron chloride, aluminum chloride and magnesium chloride. Then these compounds are combined with water to obtain Fe(OH)₂, Al(OH))³, Mg(OH)₂ which are not durable, are spongy and expand many times. NaOH is created by combining Na⁺ with water so that when then in situ materials, such as soil, soil containing clay, clay containing stone, clay containing sand, gravelly soil, saline-sand, saline containing water salt-sand and saltwater are utilized in the concrete mix used to build structures in South Vietnam, for example, upon the moisture changes, building products will expand or contract causing cracks, decreasing force-resistance and stability of the construction.

The problem is to treat or improve the unsuitable in situ building materials, such as soil, soil containing clay, clay containing stone, salt-sand and saltwater in order to turn them into aggregates suitable for use in cement mortar and concrete to build infrastructures in regions of poor soil and saline contaminated land, thus decreasing the high cost of transporting high-quality building materials such as sand, stone, water from other places, and thereby reducing the time of completing constructions.

As already known, various solutions have been proposed for making additives for building materials, such as additives for stabilizing the soil pavement and the road surface, and additives to improve protection and against corrosion of the reinforced steel concrete in regions of salt-contaminated soil or/and water, therefore increasing the solidity and durability of concrete.

However, the inventor of the present application discloses preparing a kind of additive used for treating clay/salt in the ineligible situ building materials, such as soil, soil containing clay, clay containing stone, salt-sand and saltwater, in order to change the intrinsic behavior of these materials by preventing water-reabsorption and salt-reabsorption into such materials, therefore increasing their natural weight and pressure endurance of treated materials, thus allowing to use these treated materials as aggregates for making mortar and concrete compositions that are suitable for building of infrastructure projects such as irrigation projects, traffic projects, civil projects, etc. in regions of poor or salt contaminated soil in an inexpensive and timely way.

The additive of the invention is created in a manner in which the additive for treating clay/salt is a compound having a high surfacing activated electricity which absorbs the salt-electrolytic dissociation of saltwater, and eliminates the creation of metal hydroxides and NaOH in the hydrating process of cement in saltwater in order to create inert compounds which have not been expanded or contracted.

### SUMMARY OF THE INVENTION

An object of the invention is to provide an additive (named as CSSB) used for treating clay and salt in unsuitable in situ building materials, such as soil, soil containing clay, clay containing stone, clay containing sand, gravelly soil, saline-sand, and saline-contaminated water. The CSSB additive according to the invention is a mixture of polymer solution, salts of organic acids, salts of inorganic acids and catalyst.

A second object of the invention is to provide methods for making cement-mortar and cement-concrete by using such a CSSB additive which incorporate such treated aggregates. The first object of the invention is created such that the CSSB additive is a compound having a large or high electric-activity surface which absorbs the salt-electrolytic dissociation of saltwater, and eliminates the creation of metal hydroxides and NaOH in hydrating process of cement in saltwater in order to create inert compounds which do not expand or contracted.

The second object of the invention is provided by the mixing process using the treated in situ materials as aggregates with the binder, such as Portland cement which is taken by an electro-physicochemical method under the environment of low pH. The action of the CSSB additive of the invention employs the strong electrochemistry of the main cations in soil containing salt, sand containing salt, stone containing stone and saltwater, such as Na⁺, Ca⁺⁺, Mg⁺⁺, Fe⁺⁺ and the anions, such as Cl⁻, SO₄⁻ are combined into inert compounds. Furthermore, there is an ion-exchange in this process so that the remaining substances in soil containing salt, sand containing salt, stone containing salt and saltwater are precipitated.

With respect to the above summary of the invention and background, before explaining at least one preferred embodiment of the invention in detail, it is to be understood that the invention is not limited in its application to the details of construction and to the arrangement of the components, mixtures, and/or steps set forth in the following description or illustrated in the drawings. The various mixtures and methods of the invention herein described and disclosed, are capable of other embodiments and of being practiced and carried out in various ways which will be obvious to those skilled in the art once they review this disclosure. Also, it is to be understood that the phraseology and terminology employed herein, are for the purpose of description only, and should not be regarded as limiting in any manner whatsoever.

As such, those skilled in the art will appreciate that the conception upon which this disclosure is based may readily be utilized as a basis for designing of other devices, methods and systems for carrying out the several purposes of the present disclosed mixture and product and method which allows for the inclusion of saline polluted water and unsuitable soil and material for inclusion in cement and mortar. It is important, therefore, that the objects and claims of this invention be regarded as including any such equivalent construction and methodology, as would occur to those skilled in the art, insofar as they do not depart from the spirit and scope of the present invention.

### DETAILED DESCRIPTION OF THE INVENTION

An additive (herein referred to as CSSB) for treatment of unsuitable in situ materials for inclusion into portland cement forming concrete and mortar is provided according to the present invention, which once mixed with such in situ materials provides a means to prevent water-reabsorption and salt-reabsorption into such materials which heretofore has caused the resulting concrete and mortar to be structurally unsound and crack and crumble. The mixture in a favored mode of comprises:

10% to 50% (by weight) polymer solution;

10% to 20% (by weight) salts of organic acids such as sodium carbonate (NA2CO3) or sodium phosphate (NA2PO4) or lauryl alkyl benzene sulfonate;
5% to 10% (by weight) salts of inorganic acids such as sodium carbonate or sodium phosphate;

2% to 10% (by weight) catalyst such as sulfuric acid or phosphoric acid;

10% to 73% (by weight) saltwater or salt-contaminated water.

The polymer solution used in the CSSB additive of the present invention may be, for example, a polymer styrene such as those available under the trade name of PS and is an unsaturated polyester with a styrene content of 37%-42% (by weight).
Acid value, mg KOH/g 15-25
Viscosity cps, brookfield NO-3/60 at 25° C. 400-500
gel time, min, 250 C, 1X0 MEKPO (50X0) 25-30
Thix0 tropic Index 1.4-2.2

The salts of the organic acids used in CSSB additive of the present invention may be, for example, alkyl benzene sulfonate solution, such as those available under the trade name of LABS or more generically as lauryl alkyl benzene sulfonate;

The salts of inorganic acids used in the CSSB additive of the present invention, may be used, for example, sodium carbonate (Na₂CO₃) or sodium phosphate (Na₂PO₄);

The catalyst used in the present invention, may be, for example, sulfuric acid (H₂SO₄) or phosphoric acid (H₃PO₄);

A low a range of viscosity is 10-20 m2/s is desirable.

The additive (named as CSSB) according to the present invention has the following physico-chemical characteristics:

Appearance: emulsion;

Color: opalescent;

Smell: specific pungent smell of acid;

pH≦3;

Material Density: 1.05 tons/m³;

Low average viscosity;

Not condensed at −4° C. and not boiled at 100° C.;

Eroded in concentrated form and uninfluenced by the environment when diluted;

Insoluble substances percent by weight: ≦5%.

The Example below explains in more detail referring to preparation of CSSB additive according to the present invention:

To make the CSSB additive, the PS and others compounds are needed as follows:
Unsaturated polyester resin: 10%-50% (by weight) as polymer solution
Lauryl alkyl benzene sulfonate: 10%-20% (by weight) as salts of organic acids
Sodium carbonate or sodium phosphate: 5%-10% (by weight) as salts of inorganic acid
Sulfuric acid or phosphoric acid: 2%-10% (by weight) as catalyst
Salt-water or salt-contaminated water: 10%-73% (by weight)

### EXAMPLE 1

To obtain 7 to 10 liters of CSSB additive according to the invention, the following mixture is required:

4.0 to 4.5 liters of polymer solution (such as the noted polymer solution PS);

1.8 to 2.5 liters of alkyl benzene sulfonate solution (such as the trade name: LABs);

0.05 to 0.15 liters of sodium carbonate (Na₂CO₃) or sodium phosphate (Na₂PO₄); 0.1 to 0.15 liters of sulfuric acid (H₂SO₄) or phosphoric acid (H₃PO₄); and

2.0 to 4.0 liters of saltwater or salt-contaminated water.

Larger or smaller amounts from 7 liters, would be obtained using pro rata proportions of the ingredients.

The accompanying drawing, namely FIG. 1 shows the steps in preparing CSSB additive according to the invention.

It begins by mixing 1.0 to 1.5 liters of saltwater or salt-contaminated water with 1.8 to 2.5 liters of alkyl benzene sulfonate solution (in Vietnam under the trade name: LABs) into a suitable mixer (step 11); then pour into the mixer 4.0 to 4.5 liters of polymer solution which is an unsaturated polyester with a styrene content of 37%-42% (by weight), and stir continually for several minutes (step 12); next pour into the mixer 0.05 to 0.15 liters of sodium carbonate (Na₂CO₃) or sodium phosphate (Na₂PO₄); and stir continually for several minutes (step 13); In step 14, pour into the mixer 0.1 to 0.15 liters of sulfuric acid (H₂SO₄) or phosphoric acid (H₃PO₄) and stir continually again. The CSSB additive according to the present invention is obtained at the end of step 14 by adding the remaining water (saltwater or salt-contaminated water) into the mixer.

The invention also relates to methods for making cement-mortar and cement-concrete by using unsuitable in situ building materials as aggregates which incorporate the CSSB additive according to the invention.

The method in which unsuitable in situ building materials in the invention can be used in making cement-mortar and cement-concrete which incorporate CSSB additive, and are as follows:

Saline sand, a fine grained, blackish sand, is merged with a small amount of organic mud with γ=1.2-1.4 T/m³. This sand is about 50-100 m away from a seaside, however any sand or soil which is saturated with water having a saline content is conventionally considered unsuitable for mixing with portland cement.

Soil containing clay and clay containing stone, such as a red gravel soil with the index of plasticity (Ip)=16.5% or soil-mixed clay and sandy clay;

The index of plasticity or plasticity index (engineering) is the water content percentage between the liquid limit and the plastic limit, where in the liquid limit is the water percentage between a soil's defined liquid and plastic states and the plastic limit is the water content at which the soil rolled to a 1/3 cm wire begins to crumble.

Saltwater, such as sea-water of pH=7 to 8 or salt contaminated water with the saline degree S=28.2-35 g/liter.

Generally speaking, gravelly soil is a soil containing many small stones in the soil mixture rather than just dirt or soil

The Examples bellow, namely, Example 2 explains in greater detail the preparation of the unsuitable in situ building materials for the aggregates included in the mixture by including them along with the CSSB additive. Typically unsuitable in situ material includes contaminated soil or local ground material which includes one or a combination of soil containing clay, clay containing stone. rocky or gravelly soil, saline-sand, soil with saline contaminated water saturating it, and saline sand. Saline sand is generally considered a fine grained, blackish sand, is merged with a small amount of organic mulch with y=1.2-1.4 T/m3. Salts in sand may be derived from sea water by intrusion into groundwater resources. This sand can generally be found about 50-100 m away from the coast in many areas as is the experience in Viet Nam. Greater detail is included in. Example 3 of one mode of the production of cement mortar and cement concrete using the additive herein.

### EXAMPLE 2

The production of 1 m³ of cement mortar requires a mixture of the following ingredients in the following proportions:

| | | |
|---|---|---|
| Portland cement 40 | 359 | kg |
| Saline sand | 0.9 | m³ |
| Soil contained clay | 0.3 | m³ |
| CSSB additive | 0.35 to 0.5 | liters |
| Water (seawater or salt contaminated water) | 200 to 220 | liters |

### EXAMPLE 3

The production of 1 m³ cement concrete that was made by mixing the following proportions:

| | | |
|---|---|---|
| Portland cement B40 | 350 | kg |
| Salt-sand | 0.28 | m³ |
| Sandy soil | 1.26 | m³ |
| CSSB additive | 0.3 to 0.5 | liters |
| Water (salt water or salt contaminated water) | 180 | liters |

The accompanying drawings, namely FIG. 2 shows the steps in preparing the unsuitable in situ building materials, such as soil containing clay, clay containing stone, and saline sand as the aggregates for production of cement mortar and cement concrete. FIG. 3 shows the steps in making cement mortar and cement concrete which incorporate the CSSB additive according to the invention.

After collecting soil containing clay, clay containing sand, clay containing stone, and salt-sand (step 21), it is necessary to eliminate waste from these materials (step 22), to control their index of plasticity (Ip), the degree of moisture and the degree of salinity (step 23). Controlling plasticity is determined by forming a groove in a dish of soil and impacting the dish until the groove closes.

PL (plastic limit) is conventionally determined by rolling a thread of soil on a glass plate until the ⅛-inch-diameter thread begins to crumble.

Waste in unsuitable in situ building materials may be rubbish, dropped tree-leaf, stem/trunk of trees, which are in soil and sand. Waste is eliminated from the unsuitable in situ building materials by sifting/sieving through screens of appropriate sizes in a conventional fashion.

Degree of moisture is the water content percentage of the soil. It is measured in practical moisture units (w %). Degree of salinity is the saltiness or dissolved salt content of the soil. It is measured in practical salinity units (S % 0).

The degree of salinity may be determined in many ways, but it is commonly done either by separating and weighing the salts. The degree of moisture may be determinated by using contractors and engineers. The contractors could dry soil (or allow it to dry in the sun) or could moisten the soil. At the ideal moisture content the contractor's rollers will be most effective.

Finally, these materials have to be grinded in order to adhere well with the binder (step 24).

The CSSB additive obtained in step 14 is diluted by saltwater in the desired proportions in a suitable quantity, and the mixture of CSSB additive and saltwater is stirred continually in order to create foam (step 31). Prepared situ materials in step 24 are mixed together with Portland cement 30 or 40 in the desired proportions in a suitable dispensing system. Portland Cement 30 and 40 are a conventionally employed index of compress-resistant intensity of cement and concrete.

After its 28 days hardening (step 32). The ingredients in step 32 are then mixed with the diluted CSSB additive in step 31 (step 33). Step 33 is preferably carried out in a standard mixer. The concrete mixture is then set in the mold. After four weeks, a testing of the sample similar to the testing of standard cement-mortar and cement-concrete, is conducted. Finally, the component formed by the set concrete mixture is removed from the mold (step 35).

### Comparative Effects:

(I) The technical norms of cement mortar and cement concrete made from unsuitable in situ building materials, such as soil, soil containing clay, clay containing stone, salt-sand and saltwater which incorporate CSSB additive according to the invention are as follows:

| | |
|---|---|
| Norm of plasticity before | 2 to 52%; |
| hardening: | |
| Slum before hardening: | 2 to 4 cm/minute; |
| Average coefficient of suck: | 10⁻⁶ cm/s; |
| Density: | 1.8 to 1.9 tons/m³; |
| Moisture of situ materials: | 0 to 70%; |
| Compress-resistant | suitable to building requests; |
| intensity (kg/cm²): | |
| Hardening time (by the | begin no earlier than 30 minutes and |
| minute): | end no later than 120 minutes; |
| External view: | soft, smooth, color is almost identical to |
| | color of the in situ soil (at low cement |
| | level) and like a traditional cement mortar |
| | or cement concrete. |

(ii) By not having to use clean sand (sands cleaned freshwater), clean water (freshwater) or a high-grade cement, the product decreases cost and is beneficial in protecting the environment, specifically:

| | | | Technology |
|---|---|---|---|
| | | Traditional | by using |
| | | technology | CSSB |
| No. | Norm | (USD) | additive (USD) |
| 1 | Cost price of solidification for | 3.77 to 7.54 | 3.15 to 5.00 |
| | 1 m² of irrigational construction, | | |
| | traffic construction. | | |
| 2 | Cost price of solidification | 3.15 to 6.30 | 1.89 to 5.00 |
| | for 1 m² of house-foundation | | |

(iii) The construction yields a strong, force-resistant, moisture resistant, and erosion-resistant product.

The product has been used with excellent success to solidify the embankment and wharf in Phuong Nam tourist zone and K1 embanking solidification prevents the sea wave, against erosion of beach in Dong Hoa Hamlet, Long Hoa Commune, Can Gio District, Ho Chi Minh City, Vietnam. The local sand and soil included in the concrete formed for the embankment, when treated with the additive herein and added to the portland cement prevented the heretofore unsolved problems of using contaminated local soils saturated with saline and including other contaminants noted above of cracking and crumbling. The resulting structural integrity of the concrete forming the embankment continues due to the additive herein treating the in situ materiels and thereby preventing water-reabsorption and salt-reabsorption into those materials which has plagued construction projects in the past which attempted the use of local soil and sand for inclusion into the concrete mixture.

While all of the fundamental characteristics and features of the device and method have been disclosed with reference to particular embodiments thereof, a latitude of modification, various changes and substitutions are intended in the foregoing disclosure and it will be apparent that in some instance, some features of the invention will be employed without a corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

What is claimed is:

1. An additive for treating in situ materials for inclusion into concrete, comprising:
10% to 50% (by weight) of polymer styrene as a polymer solution;
10% to 20% (by weight) of alkyl benzene sulfonate solution as salts of organic acids;
5% to 10% (by weight) of sodium carbonate (Na2CO3) or sodium phosphate (Na2PO4) as salts of inorganic acids;
2% to 10% (by weight) of sulfuric acid (H2SO4) or phosphoric acid (H3PO4) as a catalyst; and
10% to 73% (by weight) of saltwater or salt-contaminated water.

2. A method for preparing the additive of claim 1 for treating in situ materials for inclusion thereof in a concrete mix, comprising:
a) mixing alkyl benzene sulfonate solution as salts of organic acids into a portion of a supply of saltwater;
b) mixing polymer styrene as a polymer solution into the mixture formed in step (a);
c) mixing sodium carbonate (Na2CO3) or sodium phosphate (Na2PO4) as salts of inorganic acids into the mixture formed in step (b); and
d) adding the remaining of said supply of saltwater into the mixture formed in step (c).

3. The method of claim 2 further comprising:
e) collecting unsuitable in situ building materials from a group of such building materials including one or a combination of soil containing clay, sand containing clay, clay containing stone, and salt-sand;
f) screening said building materials with a sieve sized to eliminate waste from the building materials;
g) testing said building materials to control the index of plasticity (Ip), the degree of moisture and the degree of salinity of unsuitable in the building materials;
h) grinding unsuitable in situ building materials and mixing with said additive whereby said additive imparts to said in situ building materials a means to prevent water-reabsorption and salt-reabsorption into such building materials when said building materials are included with portland cement to a concrete mix and said concrete mix has hardened to a solid solution of said building materials and portland cement.

4. The additive of claim 1 included within a concrete mixture, said concrete mixture comprising:
(a) Portland cement in a proportion of 14% by weight;
(b) salt sand in a proportion of 58% weight;
(c) clay in a proportion of 18% by weight;
(d) said additive of claim in a proportion of 0.02% by weight; and,
(e) said salt-water or salt-contaminated water in a proportion of 9.98% by weight.

5. The additive of claim 1 formed in a volume of substantially seven liters for treating in situ building materials for inclusion in a concrete mix, comprising the steps of:
a) preparing a portion of substantially 4 liters of saltwater for inclusion in said additive;
b) mixing substantially 1.8 Liters of alkyl benzene sulfonate solution as salts of organic acids with substantially half of said saltwater;
c) mixing substantially 2 liters of polymer styrene as a polymer solution into the mixture of step b;
d) mixing substantially 0.05 liters of sodium carbonate (Na2CO3) or sodium phosphate (Na2PO4), as salts of inorganic acids, into the mixture of step (c); and
e) mixing the remaining of said portion of said saltwater into the above mixture of step (d).

6. The additive of claim 1 wherein employed in a concrete mixture comprising by volume:
(a) Portland cement PCB0 in a proportion of 14%;
(b) salt sand in a proportion of 58%;
(c) clay in a proportion of 18%;
(d) said additive of claim 1 in a proportion of 0.02%; and,
(e) salt-water or salt-contaminated water in a proportion of 9.98%.

7. The concrete mixture of claim 6 wherein each 1 m3 of cement concrete substantially comprises:

| | | |
|---|---|---|
| Portland cement PCB40 | 350 | kg |
| Salt-sand | 0.28 | m3 |
| Sandy soil | 1.26 | m3 |
| said additive of claim 7 | 0.3 to 0.5 | liters, and |

salt water or salt-contaminated water 180 liters whereby said additive treating said

8. The additive of claim 1 included within a concrete mixture, said concrete mixture comprising
(a) Portland cement in a proportion of 13%;
(b) Stone 0-4 cm (merged sand/soil) in a proportion of 58%
(c) Salt-sand in a proportion of 14%;
(d) said additive of claim 7 in a proportion of 0.02%; and,
(e) salt-water or salt-contaminated water in a proportion of 6.98%.
